(19) United States
(12) Patent Application Publication
(10) Pub. No.: US 2006/0003200 A1
(43) Pub. Date: Jan. 5, 2006

(54) Fuel cell unit and method for calibrating concentration value

(75) Inventors: Akihiro Ozeki, Tokyo (JP); Koji Nakamura, Tokyo (JP); Nobuo Shibuya, Kanagawa (JP); Hirohisa Miyamoto, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/170,167

(22) Filed: Jun. 30, 2005

(30) Foreign Application Priority Data
Jun. 30, 2004 (JP) P2004-194948

(51) Int. Cl. H01M 8/04; H01M 8/12

(52) U.S. Cl. 429/14; 429/23

(57) ABSTRACT

A fuel cell unit being capable of calibrating a concentration value of an aqueous fuel solution by use of a reference concentration value, including: a fuel cell; a fuel tank which stores a fuel for the fuel cell; a mixing tank which produces the aqueous fuel solution supplied to the fuel cell; a concentration sensor which detects the concentration of the aqueous fuel solution produced in the mixing tank; a fuel pump which feeds, into the mixing tank, the fuel of the fuel tank; and a controller which acquires a current value output from the fuel cell and the concentration value of the aqueous fuel solution, both of which vary by controlling the fuel pump, and calibrates the concentration value of the aqueous fuel solution by use of the acquired concentration value of the aqueous fuel solution and the reference concentration value.

### CROSS-REFERENCE TO RELATED APPLICATIONS

This application is based upon and claims the benefit of priority from the prior Japanese Patent Application No. 2004-194948, filed on Jun. 30, 2004; the entire contents of which are incorporated herein by reference.

### BACKGROUND OF THE INVENTION

1. Field of the Invention

The present invention relates to a control technique for effectively supplying. fuel to a fuel cell, such as a direct methanol fuel cell.

2. Description of the Related Art

In recent years, electronic equipment, such as a notebook-type personal computer, which can operate on a battery has been widely spread. In addition, in consideration of environmental issues, development has recently started on electronic equipment which employs a fuel cell, which does not produce hazardous waste.

A direct methanol fuel cell (hereinafter also called “DMFC”) induces reaction between methanol and oxygen, which are supplied as fuel, thereby acquiring electrical energy from the chemical reaction. The DMFC is configured to have two electrodes, constituted of a porous metal or carbon, which sandwich an electrolyte. The fuel methanol is diluted with an aqueous solution recovered from the DMFC in a mixing tank, and supplied to the DMFC as an aqueous fuel solution.

Efficiency of the fuel cell is highly dependent on controlling a fuel concentration value of the aqueous fuel solution; that is, controlling a fuel pump for feeding methanol to the mixing tank. Similar methods applicable to a control of this kind include, for instance, a method for controlling an air blower or a valve in a power plant (see, e.g., JP-A-2003-217624).

The method disclosed in JP-A-2003-217624 is such a method that a deviation in an oxygen flow rate and an oxygen partial pressure are estimated by means of taking as inputs signals obtained from a current sensor and a voltage sensor, whereupon the air blower and the valve are controlled so as to bring the oxygen flow rate close to a standard value.

### BRIEF SUMMARY OF THE INVENTION

Meanwhile, in conventional control methods, including that of JP-A-2003-217624, target standard values of respective objects monitored by a variety of sensors are uniformly determined to identical values. Accordingly, the variety of sensors must have extremely high accuracy so as to exhibit no variations in outputs values, and the like. Therefore, when an attempt is made to apply the method to control of a fuel concentration value of an aqueous fuel solution, a highly-accurate fuel concentration sensor must be employed, thereby increasing a total cost of a fuel cell unit on which the DMFC is mounted. In addition, even when the fuel concentration sensor itself has no problem, when deterioration and the like due to a secular change occurs in a member which exerts an influence on a result of measurement by the fuel concentration sensor, calibration for absorbing the deterioration encounters great difficulty. Furthermore, in view of fuel efficiency of the DMFC, the accuracy of the fuel concentration sensor is desirably enhanced as much as possible.

The present invention has been conceived in view of the above circumstances, and an object thereof is to provide a fuel cell unit which enables stable control of a fuel concentration value of an aqueous fuel solution, and a method for calibrating a concentration value.

According to an aspect of the invention, there is provided a fuel cell unit being capable of calibrating a concentration value of an aqueous fuel solution by use of a reference concentration value, including: a fuel cell; a fuel tank which stores a fuel for the fuel cell; a mixing tank which produces the aqueous fuel solution supplied to the fuel cell; a concentration sensor which detects the concentration of the aqueous fuel solution produced in the mixing tank; a fuel pump which feeds, into the mixing tank, the fuel of the fuel tank; and a controller which acquires a current value output from the fuel cell and the concentration value of the aqueous fuel solution, both of which vary by controlling the fuel pump, and calibrates the concentration value of the aqueous fuel solution by use of the acquired fuel concentration value and the reference concentration value.

According to another aspect of the invention, there is provided a method for calibrating a concentration value of an aqueous fuel solution which is produced in a mixing tank and supplied to a fuel cell, by means of activating a fuel pump to thus feed a fuel to the mixing tank, including: acquiring a current value output from the fuel cell and the concentration value of the aqueous fuel solution, both of which vary by means of controlling the fuel pump; and calibrating the concentration value of the aqueous fuel solution by use of the acquired concentration value of the aqueous fuel solution and a reference concentration value.

According to the invention, there can be provided the fuel cell unit that enables stable control of the concentration value of the aqueous fuel solution, and the method for calibrating the concentration value.

### BRIEF DESCRIPTION OF THE DRAWINGS

FIG. 1 is a view showing the exterior of an electronic equipment system according to an embodiment of the present invention;

FIG. 2 is a view showing the configuration of a fuel cell unit of the embodiment;

FIG. 3 is a view showing the configuration of a DMFC mounted on the fuel cell unit of the embodiment;

FIG. 4 is a flowchart showing a procedure of calibration of a fuel concentration value detected by a concentration sensor, which is performed by the fuel cell unit of the embodiment;

FIG. 5 is a view showing a typical example of a fuel concentration-output current characteristic; and

FIG. 6 is an example graph, showing a fuel concentration in a mixing tank along the X-axis and a state of the DMFC along the Y-axis.

### DETAILED DESCRIPTION OF THE INVENTION

An embodiment of the present invention will be described with reference to the drawings hereinbelow.

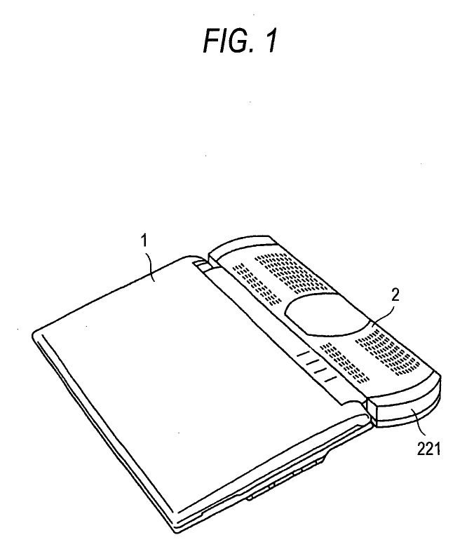

FIG. 1 is a view showing the exterior of an electronic equipment system according to an embodiment of the present invention.

The electronic equipment system includes electronic equipment 1, and a fuel cell unit 2 which is detachable to and from the electronic equipment 1. The electronic equipment 1 is a so-called notebook-type personal computer, and can operate on power supplied from the fuel cell unit 2. The fuel cell unit is a direct methanol fuel cell which generates power by means of inducing reaction between methanol and air (oxygen). A cartridge-type fuel tank 221 for storing methanol, which serves as a fuel, is detachable to and from the fuel cell unit.

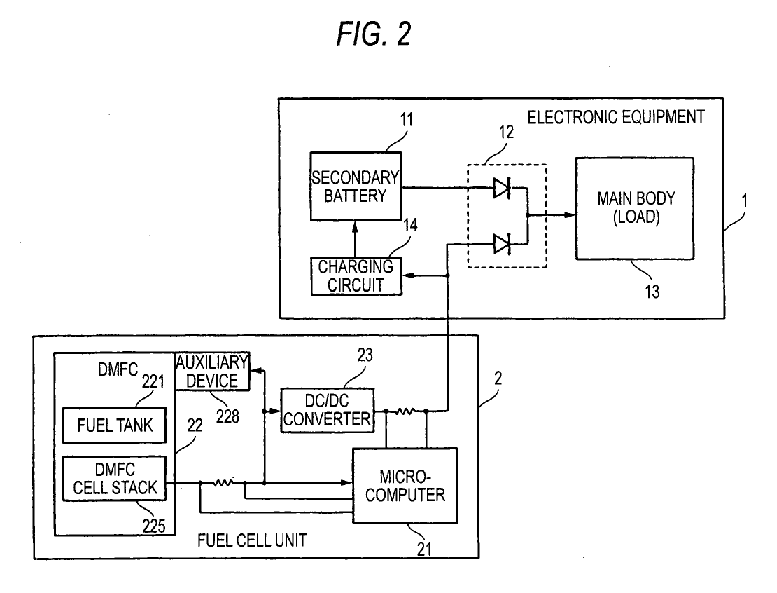

FIG. 2 is a view showing the configuration of the fuel cell unit 2. A microcomputer 21 for use in control is provided in the fuel cell unit 2, and power is generated by a DMFC 22 under control of the microcomputer 21. The DMFC 22 generates power by means of inducing chemical reaction between the methanol and air stored in the fuel tank 221 in a reaction section which is called a DMFC cell stack 225. An auxiliary device 228 is disposed for feeding methanol and air to the DMFC cell stack 225. The microcomputer 21 controls the amount of power generated by the DMFC cell stack 225 by means of controlling operation of the auxiliary device 228.

The power output from the DMFC cell stack 22; that is, the power output from a DC/DC converter 23, is subjected to parallel connection, in the electronic equipment 1 to which the power is to be supplied, by means of a secondary battery 11, such as a lithium-ion battery, and a diode OR circuit 12. A current value of the power output from the DMFC cell stack 22 is monitored by the microcomputer 21.

The microcomputer 21 controls operation of the DC/DC converter 23 so that, when a power load of a main body section 13 is lower than an amount of power currently being generated by the DMFC 22, an output voltage of the DC/DC converter becomes higher than that of the secondary battery 11, to thus feed power only from the DMFC 22; and, when the same exceeds the amount of power currently being generated, the output voltage of the DC/DC converter 23 is made to balance with that of the secondary battery 11, to thus feed power from the secondary battery 11 as well as from the DMFC 22.

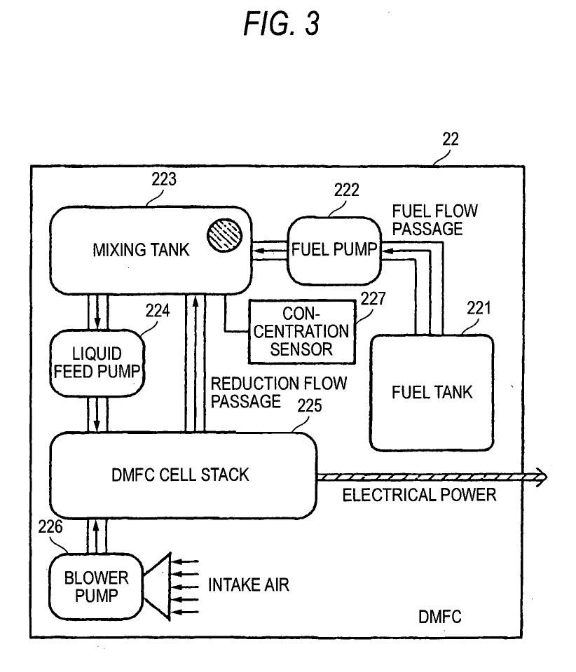

A charging circuit 14 for charging the secondary battery 11 is disposed in the electronic equipment 1. The charging circuit 14 performs such a so-called floating charging to the secondary battery 11 that, when the power load of the main body section 13 is lower than the power supplied from the fuel cell unit 2, the secondary battery 11 is charged with the surplus power. Next, FIG. 3 shows the configuration of the DMFC 22.

As shown in FIG. 3, the DMFC 22 includes the fuel tank 221, a fuel pump 222, a mixing tank 223, a liquid feed pump 224, the DMFC cell stack 225, and a blower pump 226. The fuel pump 222, the liquid feed pump 224, and the blower pump 226 are included in the auxiliary device 228 shown in FIG. 2.

Methanol in the fuel tank 221 is fed to the mixing tank 223 by means of the fuel pump 222, where the methanol is mixed with an aqueous solution recovered from the DMFC cell stack 225 to thus be diluted. Hence, an aqueous fuel solution is obtained. A concentration sensor 227 for detecting a concentration of the aqueous fuel solution in the mixing tank 223 is disposed. The concentration sensor 227 transmits a fuel concentration value to the microcomputer 21. On the basis of a result of detection by the concentration sensor 227, the microcomputer 21 controls the amount of fuel fed to the mixing tank 223 fed by the fuel pump 222. Examples of the concentration sensor 227 include a type which detects a concentration by use of a characteristic that a transmission speed of a sound wave in an aqueous fuel solution varies depending on its concentration; and a type which determines a concentration by means of measuring a dielectric constant of an aqueous fuel solution. Either type of concentration sensor may be employed, so long as a target concentration can be measured.

The aqueous fuel solution in the mixing tank 223 is fed to the DMFC cell stack 225 by means of the liquid feed pump 224. In addition, air is fed to the DMFC cell stack 225 by means of the blower pump 226. As a result, in the DMFC cell stack 225, methanol in the aqueous fuel solution and oxygen in the air react, thereby generating power. The microcomputer 21 according to the embodiment performs appropriate calibration of the fuel concentration value, which is detected by the concentration sensor 227, of the aqueous fuel solution produced in the mixing tank 223.

Next, a basic principle of calibration of a fuel concentration value detected by the concentration sensor 227, which is performed by the microcomputer 21 of the embodiment, will be described.

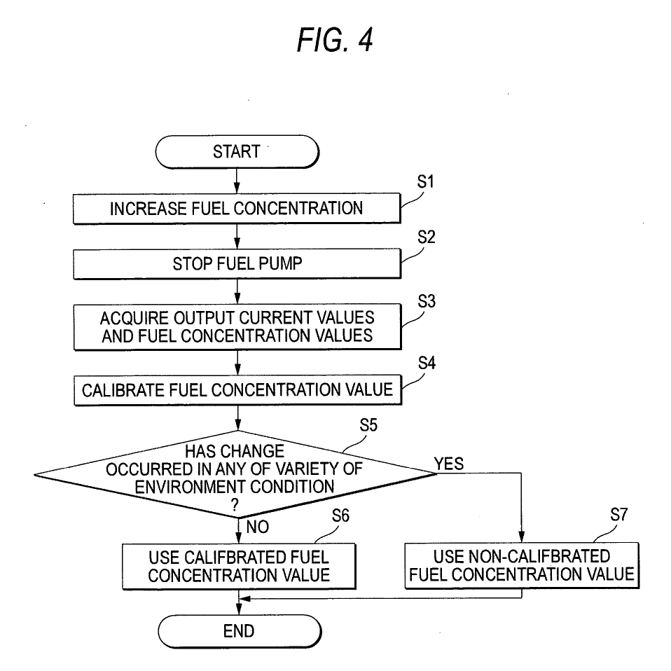

FIG. 4 is a flowchart showing a procedure of the calibration of a fuel concentration value detected by the concentration sensor 227, which is performed by the microcomputer 21 of the embodiment.

The microcomputer 21 controls the fuel pump 22 so as to increase the amount of fuel supplied to the mixing tank 223, to thus increase the fuel concentration value of the aqueous fuel solution in the mixing tank 223 (step S1).

The concentration sensor 227 detects a fuel concentration of the aqueous fuel solution in the mixing tank 223. When the fuel concentration of the aqueous fuel solution reaches a predetermined value, the microcomputer 21 controls the fuel pump 222 so as to stop feeding of the fuel to the mixing tank 223, while operating the liquid feed pump 224 in a normal manner (step S2). In other words, the microcomputer 21 temporarily increases the fuel concentration of the aqueous fuel solution produced in the mixing tank 223, and thereafter gradually lowers the same.

When the microcomputer 21 controls the concentration of the aqueous fuel solution in the mixing tank 223 by means of performing the above-mentioned control of the fuel pump 222, and the like, the microcomputer 21 acquires current values output from the DMFC cell stack 225 and fuel concentration values detected by the concentration sensor 227 (step S3).

The microcomputer 21 performs calibration of the fuel concentration value detected by the concentration sensor 227 by use of the output current values, the fuel concentration values, and a fuel concentration-output current characteristic, which will be described later (step S4).

In addition, during the calibration of the fuel concentration value detected by the concentration sensor 227, the microcomputer 21 determines whether or not any change has occurred in a variety of environmental conditions (e.g., a temperature condition or a stack voltage) of the DMFC 22 (step S5).

When no change has occurred in the environmental conditions (when the result of step S5 is NO), the fuel concentration value calibrated in step S5 is used (step S6).

Meanwhile, when occurrence of a change is recognized in the environmental conditions (when the result of step S6 is YES), the microcomputer 21 does not use the fuel concentration value calibrated in step S5, and uses the non-calibrated fuel concentration value detected by the concentration sensor 227 (step S7).

As a result, usage of an inappropriate fuel concentration value, affected by a change in the variety of environmental conditions of the DMFC 22, is prevented.

Meanwhile, refreshing of the fuel cell unit 2 may be performed by the microcomputer 21 as required when the fuel concentration value in the mixing tank 223 is calibrated by use of the concentration sensor 227. Refreshing referred to here is such processing as forcibly washing and removing bubbles and water droplets affixed to a fuel electrode and an air electrode of the DMFC 225 by means of injecting an aqueous methanol solution to the fuel cell and the air to the air electrode for a predetermined period of time in a mode different from a normal power generation mode; for instance, with a higher pressure. By means of performing refreshing, output power generated by the DMFC cell stack 225 is stabilized. Next, the fuel concentration-output current characteristic will be described.

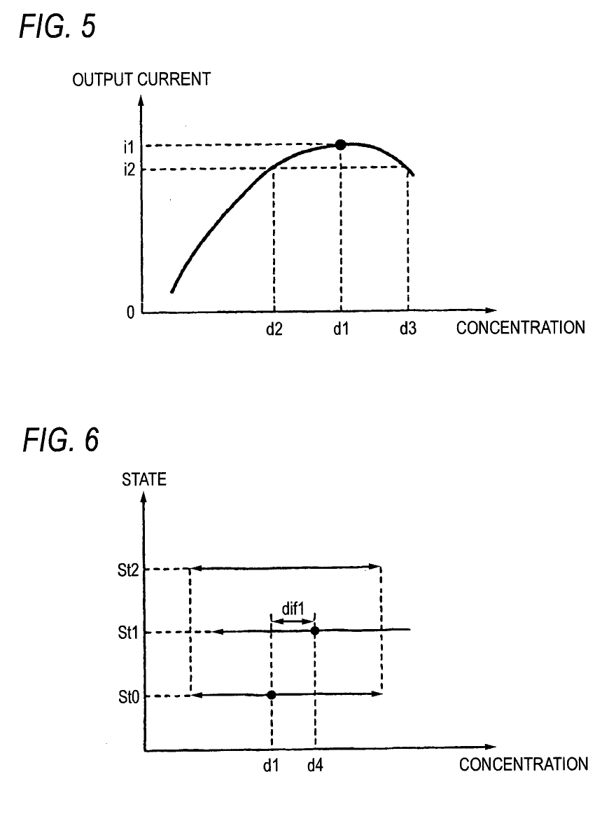

FIG. 5 is a view showing a typical example of the fuel concentration-output current characteristic.

When, for instance, a current value output from the DMFC cell stack 225 coincides with a peak output current value i1 as shown in FIG. 5, a fuel concentration value corresponding to the peak output current value i1 is uniquely determined to be d1. Meanwhile, when an output current value of the DMFC cell stack 225 is i2, a fuel concentration value takes d2 and d3. When the microcomputer 21 performs calibration of the fuel concentration value detected by the concentration sensor 227, the microcomputer 21 uses as a reference fuel concentration value the fuel concentration value d1, at which the current value output from the DMFC cell stack 225 is in a unique relationship with the peak output current value i1 . Next, a method for controlling a fuel concentration value by the microcomputer 21 will be described.

FIG. 6 is an example graph, showing a fuel concentration in the mixing tank 223 along the X-axis, and a state of the DMFC 22 along the Y-axis.

A state St0 denotes a state where a fuel concentration value detected by the concentration sensor 227 includes no significant error. The fuel concentration d1 in state St0 denotes a concentration where a current value output from the DMFC cell stack 225 takes the peak output current value described previously by reference to FIG. 4.

A state St1 denotes a state where a predetermined period of time has elapsed since state St0. When a predetermined period time has elapsed from state St0, a fuel concentration value detected by the concentration sensor 227 includes some error.

In state St1, when the microcomputer 21 controls the concentration of the aqueous fuel solution in the mixing tank 223 by means of performing the above-described control of the fuel pump 222, and the like, the microcomputer 21 acquires current values output from the DMFC cell stack 225 and fuel concentration values detected by the concentration sensor 227. The microcomputer 21 refers to the thus-acquired current values output from the DMFC cell stack 225, thereby finding a peak output current value. Furthermore, the microcomputer 21 finds, among the thus-acquired fuel concentration values, a fuel concentration value d4 corresponding to the peak output current value having been found by the microcomputer 21.

In state St1, the microcomputer 21 calibrates a fuel concentration value detected by the concentration sensor 227. A calibration method of a fuel concentration value by the microcomputer 21 is as follows. First, the microcomputer 21 calculates a difference dif1 between the fuel concentration value d1 and the fuel concentration value d4. Next, the microcomputer 21 takes into consideration (adds/subtracts) the thus-calculated difference difl in (to/from) the fuel concentration value detected by the concentration sensor 227.

In the example shown in FIG. 6, the microcomputer 21 calculates the difference difl from the fuel concentration value in state St1, whereby a fuel concentration value having been calibrated by the microcomputer 21, as shown by state St2, is obtained. More specifically, the microcomputer 21 performs calibration such that the result of detection by the concentration sensor 227 in state St1 ¾ where the result includes an error ¾ becomes the result of detection by the concentration sensor 227 in state St0 ¾ where the result includes no significant error.

As described above, the microcomputer 21 calibrates. a fuel concentration value detected by the concentration sensor 227 by use of current values output from the DMFC cell stack 225, fuel concentration values detected by the concentration sensor 227, and the fuel concentration value d1 acquired by use of the fuel concentration-output current characteristic having been described by reference to FIG. 5 in accordance with a change, thereby enabling stable control of fuel concentration of an aqueous fuel solution.

Meanwhile, the present invention is not limited to the embodiment. When being practiced, the invention can be embodied while modifying the constituent elements within the scope of the invention. In addition, a variety of inventions can be formed by means of appropriately combining the plurality of constituent elements disclosed in the embodiment. For instance, some elements may be omitted from the elements described in embodiments. Moreover, elements used in different embodiments may be combined appropriately.

Incidentally, the reference fuel concentration value is set as to correspond to a value in a state where the output and the fuel efficiency the fuel cell are within appropriate ranges.

What is claimed is:

1. A fuel cell unit being capable of calibrating a concentration value of an aqueous fuel solution by use of a reference concentration value, comprising:
a fuel cell;
a fuel tank which stores a fuel for the fuel cell;
a mixing tank which produces the aqueous fuel solution supplied to the fuel cell;
a concentration sensor which detects the concentration value of the aqueous fuel solution produced in the mixing tank;
a fuel pump which feeds, into the mixing tank, the fuel of the fuel tank; and
a controller which acquires a current value output from the fuel cell and the concentration value of the aqueous fuel solution, both of which vary by controlling the fuel pump, and calibrates the concentration value of the aqueous fuel solution by use of the acquired concentration value of the aqueous fuel solution and the reference concentration value.

2. The fuel cell unit according to claim 1, wherein the reference concentration value is a concentration value corresponding to a peak current value output from the fuel cell in a state where the influence of an error included in the concentration value of the aqueous fuel solution is small; and
the controller acquires a difference between the acquired concentration value corresponding to the peak output current value in the acquired output current value and the reference concentration value, and performs calibration of the concentration value of the aqueous fuel solution while taking into consideration the difference.

3. The fuel cell unit according to claim 1, wherein the controller controls the fuel pump so as to increase the concentration value of the aqueous fuel solution produced in the mixing tank, and thereafter stops the fuel pump so as to lower the concentration value of the aqueous fuel solution produced in the mixing tank.

4. The fuel cell unit according to claim 1, wherein, when an environmental condition has changed during the course of the current value output from the fuel cell and the concentration value of the aqueous fuel solution being varied by means of controlling the fuel pump, the controller does not use a value determined by calibration of the concentration value of the aqueous fuel solution.

5. A method for calibrating a concentration value of an aqueous fuel solution which is produced in a mixing tank and supplied to a fuel cell, by means of activating a fuel pump to thus feed a fuel to the mixing tank, comprising:
acquiring a current value output from the fuel cell and the concentration value of the aqueous fuel solution, both of which vary by means of controlling the fuel pump; and
calibrating the concentration value of the aqueous fuel solution by use of the acquired concentration value and a reference concentration value.

6. The method for calibrating a concentration value according to claim 5, wherein the reference concentration value is a concentration value corresponding to a peak current value output from the fuel cell in a state where an influence of an error included in the concentration value of the aqueous fuel solution is small; and
a difference between the acquired concentration value corresponding to the peak output current value in the acquired output current value and the reference concentration value is determined, and the concentration value of the aqueous fuel solution is calibrate while taking into consideration the difference.

7. A fuel cell unit being capable of calibrating a concentration value of an aqueous fuel solution by use of a reference concentration value, comprising:
a fuel cell;
a fuel tank which stores a fuel for the fuel cell;
a mixing tank which produces the aqueous fuel solution supplied to the fuel cell;
a concentration sensor which detects the concentration of the aqueous fuel solution produced in the mixing tank;
a fuel pump which feeds, into the mixing tank, the fuel of the fuel tank; and
a controller which controls the fuel pump so as to increase the concentration value of the aqueous fuel solution produced in the mixing tank and thereafter stops the fuel pump so as to lower the concentration value of the aqueous fuel solution produced in the mixing tank, then acquires a current value output from the fuel cell and the concentration value of the aqueous fuel solution, both of which vary by controlling the fuel pump, and calibrates the concentration value of the aqueous fuel solution by use of the acquired concentration value of the aqueous fuel solution and the reference concentration value.
